(19) United States
(12) Patent Application Publication
(10) Pub. No.: US 2009/0038309 A1
(43) Pub. Date: Feb. 12, 2009

(54) Supercharging device

(76) Inventors: Oliver Cocca, Munchen (DE); Guenther Vogt, Holzkirchen (DE); Andre Wittmer, Holzkirchen (DE); Peter Albrecht, Hebertshausen (DE); Andreas Huber, Grosskarolinenfeld (DE); Uwe Hammer, Hausham (DE); Bodo Becker, Oberlaindern (DE)

Correspondence Address: KENYON & KENYON LLP, ONE BROADWAY, NEW YORK, NY, 10004, US

(21) Appl. No.: 12/220,976

(22) Filed: Jul. 29, 2008

(30) Foreign Application Priority Data
Aug. 6, 2007 (DE) 102007037087.5

(51) Int. Cl. F02D 23/00; F02B 37/007; F02B 37/013

(52) U.S. Cl. 60/603; 60/612

(57) ABSTRACT

A supercharging device, especially for supercharging internal combustion engines, having a first supercharging device and an additional supercharging device, which each have one compressor part and each have one turbine part, and a supercharging pressure prevails in an intake manifold on the intake side of the internal combustion engine, and an exhaust gas counterpressure prevails in an exhaust gas manifold, on the outlet side of the internal combustion engine. A switching element is provided, in the intake tract of the internal combustion engine, between the compressor part of the first supercharging device and the compressor part of the additional supercharging device, using which, switching over is performed from the series connection of the compressor parts to the parallel connection of the compressor parts and vice versa.

### CROSS REFERENCE

This application claims the benefit under 35 U.S.C. § 119 of German Patent Application No. 102007037087.5, filed on Aug. 6, 2007, which is expressly incorporated herein by reference in its entirety.

### BACKGROUND INFORMATION

The supercharging of internal combustion engines with the aid of supercharging devices, such as exhaust-gas turbochargers, is a generally recognized method for increasing the specific power output of the internal combustion engine. The disadvantage of this supercharging method is the responsiveness of the supercharging device if developed in particular as an exhaust gas turbocharger, which goes along with the so-called “turbocharger lag”. Because of the inertia of the running gear, the boost pressure buildup, and with that the torque characteristic does not take place ideally fast, as would be expected in an equal-powered naturally aspirated engine. The delay setting in between the torque command and the acceleration of the vehicle is perceived by the driver as unpleasant. Various methods are used to rectify this disadvantage, among others, using two supercharging devices. The two supercharging devices used, that are preferably developed as exhaust gas turbochargers, may be interconnected to each other in various ways. Interconnections that are particularly advantageous are yielded by two-stage, regulated supercharging on the one hand, and by sequential supercharging on the other hand.

In a two-stage supercharging of internal combustion engines, two supercharging devices developed as exhaust gas turbochargers are generally connected in series. This allows two-stage expansion via the two turbine parts of the two exhaust-gas turbochargers to be achieved, as well as two-stage compression on the compressor side of the two exhaust-gas turbochargers interconnected in series. Because of the layout of the high-pressure turbine and the low-pressure turbine in unregulated two-stage supercharging, there exists an unsatisfactory responsiveness, both in the operating range up to reaching the design point as well as after exceeding it. The disadvantages of uncontrolled, two-stage supercharging are prevented by control elements for bypassing the high-pressure turbine and the high-pressure compressor. The performance of the high-pressure turbine is regulated by the deactivation of the exhaust-gas mass flow before the high-pressure turbine. The exhaust gas mass flow exiting from the high-pressure turbine mixes with the part of the exhaust gas mass flow that flows through a bypass flap, and is subsequently expanded in the low-pressure turbine.

In the case of sequential supercharging devices, a first register stage having a first compressor part and a first turbine part is provided, as well as a second register stage having a second compressor part and a second turbine part. The sequential supercharging device is used for supercharging an internal combustion engine, to which is preconnected at least one intercooler on the intake side, a compressor sequence valve being assigned to the second register stage. A turbine sequence valve may be assigned to the second turbine part of the register supercharging device, via which a supercharging control takes place in the first register stage, a wastegate valve being assigned to the second register stage.

In sequential supercharging, the two supercharging devices developed as exhaust gas supercharger are connected in parallel to each other, and by doing this, at low throughputs, at first one of the turbine parts has an exhaust gas flow applied to it. Because of that, only one running gear, that is, the mutually coupled runners of the turbine part and the compressor part of one of the two exhaust gas turbochargers has to be accelerated when an abrupt change in load takes place due to low rotational speeds. Only when the air mass flow of this one exhaust gas turbocharger is no longer sufficient is the second exhaust gas turbocharger switched in. There are various possibilities for implementing the sequential supercharging.

### SUMMARY

It is an object of the present invention to combine the advantages of the two interconnection types, that is, the two-stage controlled supercharging and the sequential supercharging.

Following the design approach proposed according to the present invention, the two supercharging devices of exhaust gas turbocharger nature are preferably first of all operated serially, which is equivalent to stage supercharging. If the requirement for fresh air increases further, the two compressor parts of the two interconnected exhaust gas turbochargers are connected in parallel. In this way they are able to convey the sum of the respectively possible individual mass flows.

It is possible, using the design approach according to the present invention, to switch over in one part of the operating range of the internal combustion engine from two-step supercharging to the operating mode of sequential supercharging, so that, in the operating mode of sequential supercharging, a greater air mass flow is able to be conveyed than would be possible because of the larger of the single compressors of the two supercharging devices that are preferably developed as exhaust gas turbochargers. The supercharging system can thereby be used in optimal fashion. As to the design, the possibility comes about, in an advantageous manner, of using exhaust gas turbochargers taking up less space, which runs counter to currently prevailing development tendencies in the development of modern, high-performance and compactly built internal combustion engines. Using a smaller size of these turbo engines, that is, of the turbine part and the compressor part of the supercharging device preferably developed using two exhaust gas turbochargers, a reduction in the mass inertia automatically goes along with this, which in turn has a positive effect on the achievable responsiveness.

Because of the system proposed according to the present invention, a supercharging device may be provided in which the two supercharging devices preferably developed as exhaust gas turbochargers may first of all be operated serially, and in case of an increasing air requirement, that is, in response to an increasing rotational speed of, and load on the internal combustion engine, the two compressor parts of the two supercharging devices developed as exhaust gas turbochargers are able to be connected in parallel, whereby the sum of the individual mass flows is available for supercharging the internal combustion engine.

### BRIEF DESCRIPTION OF THE DRAWINGS

Example embodiments of the present invention are explained in greater detail below on the basis of the figures.

FIG. 1 shows the interconnection scheme of a two-stage controlled supercharging device design.

FIG. 2 shows a switching scheme for a supercharging device that is operable as a sequential supercharging device.

FIG. 3 shows the switching scheme of the supercharging device proposed according to the present invention.

### DETAILED DESCRIPTION OF EXAMPLE EMBODIMENTS

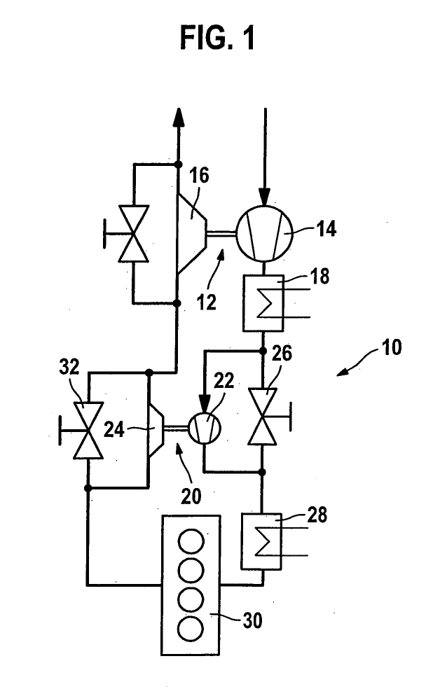

In the illustration of FIG. 1 shows circuit scheme for a supercharging device that is designed for two-stage control.

FIG. 1 shows a supercharging device 10 which preferably has a first exhaust gas turbocharger 12 and an additional exhaust gas turbocharger 20. First exhaust gas turbocharger 12 includes a compressor part 14 and a turbine part 16, and additional exhaust gas turbocharger 20 includes a compressor part 22 and a turbine part 24. In both exhaust gas turbochargers 12, 20 respective compressor parts 14, 22 are coupled to respective turbine parts 16, 24 via a rigid shaft.

In the arrangement shown in FIG. 1, first exhaust gas turbocharger 12 is used as a low-pressure supercharger, while additional exhaust gas turbocharger 20 is used as a high-pressure supercharger.

An optional intercooler 18 is connected downstream from compressor part 14 of first exhaust gas turbocharger 12, via which the partially compressed fresh air is supplied either to compressor part 22 of additional exhaust gas turbocharger 20, or is supplied via a compressor bypass 26 to an additional second intercooler 28. The air cooled again in second intercooler 28 is available on the intake side at internal combustion engine 30 for improving the charge in the combustion chambers of internal combustion engine 30.

At the outlet side, exhaust gas flows via an exhaust manifold only indicated in the illustration according to FIG. 1, which has an exhaust gas counterpressure, either via a turbine bypass 32 and/or turbine part 24 of additional supercharging device 20 and may possibly be expanded once more in turbine part 16 of first supercharging device 12, for instance, to the environmental pressure level, and is then emitted to the environment.

In the arrangement according to FIG. 1, the two exhaust gas turbochargers 12, 20 are connected in series, in order to achieve a two-stage expansion over the two turbine parts 16 and 24, as well as to obtain a two-stage compression by compressor parts 14, 22. The disadvantages of an uncontrolled two-stage supercharging method are avoided by turbine bypass 32 for the circumvention of the high-pressure turbine, that is, of turbine part 24 of additional exhaust gas turbocharger 20, and by compressor bypass 26 for the circumvention of the high-pressure compressor, that is, compressor part 22 of additional exhaust gas turbocharger 20.

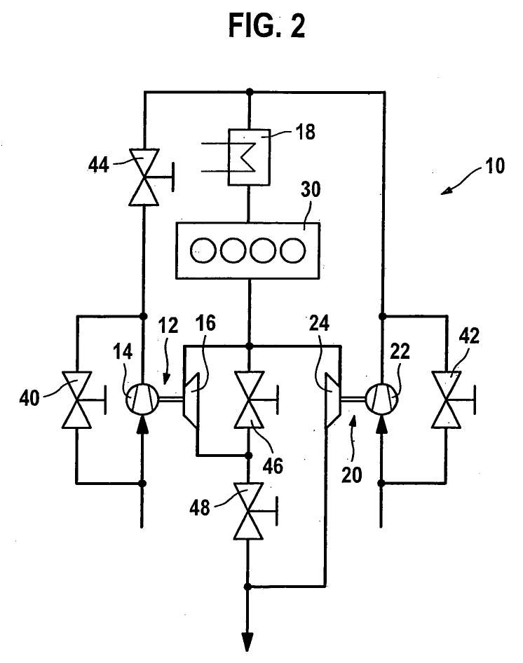

In general, flaps to be operated from outside are provided for this. Compressor bypass 26, which conveys the fresh air past compressor part 22, has the task of reducing the work of compressor part 22 of additional exhaust gas turbochargers 20 in the case where it is no longer able meaningfully to contribute to the compression. This is the case, for instance, when the volume flow over compressor part 22 of additional exhaust gas turbocharger 20 becomes greater, and the choke line is reached. The control of a turbine bypass 32 for circumventing turbine part 24 of additional exhaust gas turbochargers 20 has the effect that the driving power may be reduced independently of the reaching of the choke line. FIG. 2 shows schematically the arrangement of a supercharging device in which the method of sequential supercharging is realized.

In this variant embodiment, the two supercharging devices preferably characterized as exhaust gas turbochargers 12, 20 are connected in parallel. At low volume air flow, in this instance, at first only one of turbine parts 16, 24 of the two exhaust gas turbochargers 12, 20, that are connected in parallel, has exhaust gas applied to it. Because of this, the possibility exists that only one running gear is to be accelerated, when an abrupt change in load at internal combustion engine 30 from low speeds to high speeds, or higher loads, takes place. Only in the case that the air mass flow supplied by one of exhaust gas turbochargers 12, 20 is no longer sufficient is the remaining one of the two exhaust gas turbochargers 12, 20 switched on.

As shown in FIG. 2, a compressor bypass 40 is assigned to first exhaust gas turbocharger 12 and an additional compressor bypass 42 is assigned to compressor part 22 of the additional turbocharger device 20. A throttling point is designated by position 44, which is connected downstream from compressor part 14 of first exhaust gas turbocharger 12. The two compressor parts 14 and 22 convey the air mass flow, compressed in each case to supercharging level, to intercooler 18 which is preconnected to internal combustion engine 30 on its intake side.

On the outlet side of internal combustion engine 30, the exhaust gas flows via an exhaust gas manifold, that is only schematically indicated in FIG. 2, to both turbine parts 16, 24 of exhaust gas turbochargers 12, 20. In the arrangement shown in FIG. 2, a turbine bypass 46 is connected in parallel with turbine part 16 of first exhaust gas turbocharger 12. A valve 48 is situated downstream from the opening-out point of expansion channel 16 of additional exhaust gas turbocharger 20.

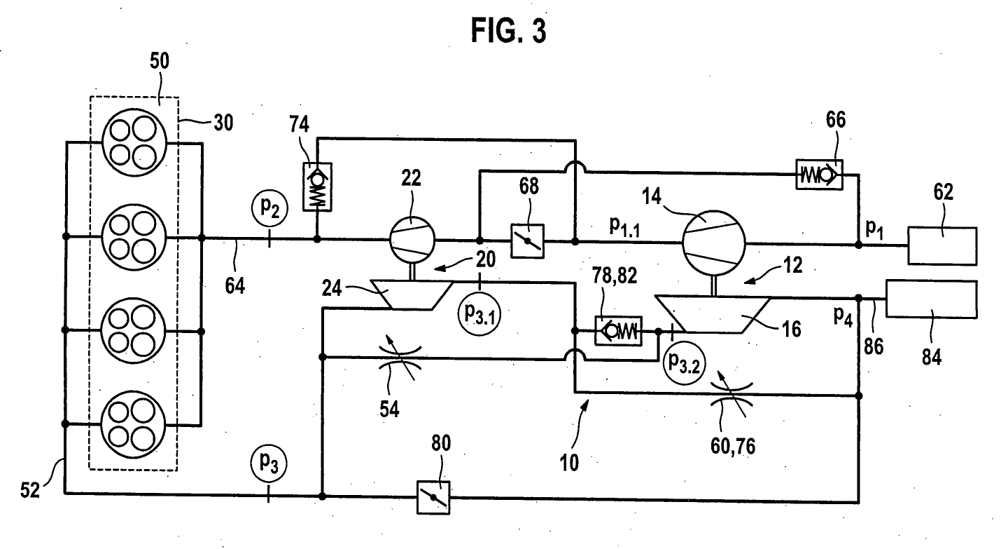

In the illustration according to FIG. 3, a variant embodiment of the interconnection of the supercharging device proposed according to the present invention is shown, in which the advantages of the two-stage controlled supercharging shown in FIG. 1 and of the sequential supercharging shown in FIG. 2 are combined with each other.

Supercharging device 10 shown in FIG. 3 is applied to an internal combustion engine 30, whose cylinder head is indicated by reference numeral 50 in the illustration according to FIG. 3. To cylinder head 50, of internal combustion engine 30, there is assigned an intake manifold 64 on the intake side and an exhaust manifold 52 on the outlet side.

The exhaust gas from exhaust gas manifold 52 of internal combustion engine 30 reaches turbine part 24 of additional exhaust gas turbocharger 20, which represents the high-pressure supercharger in the specific embodiment shown in FIG. 3. In the case in which supercharging device 10 shown in FIG. 3 is operated in two-stage supercharging, a first throttle valve 54, which is connected in parallel with turbine part 24 of additional exhaust gas turbocharger 20, is closed. This means that no exhaust gas is conveyed past turbine part 24 of additional exhaust gas turbocharger 20, which is the high-pressure supercharger in this case.

The pressure prevailing at the outlet of turbine part 24, of additional exhaust gas turbocharger 20, which represents the high-pressure supercharger, is characterized by p_{3.1}, and corresponds to the pressure at the intake of turbine part 16 of first exhaust gas turbocharger 12, less a pressure loss which sets in via a third check valve 78, and which, in the specific embodiment of the present invention, represents the low-pressure supercharger according to FIG. 3. This pressure is designated by p_{3.2}. A second throttle valve 60, connected in parallel to turbine part 16 of first exhaust gas turbocharger 12 of the low-pressure supercharger, is also closed, so that the entire exhaust gas which, at closed first throttle valve 54, flows via turbine part 24 of additional exhaust gas turbocharger 20 of the high-pressure supercharger, also flows via turbine part 16 of first exhaust gas turbocharger 12 of the low-pressure supercharger. As seen from the fresh air side, first exhaust gas turbocharger 12 representing the high-pressure supercharger is postconnected to exhaust gas turbocharger 20 that represents the low-pressure supercharger. The two exhaust gas turbochargers 12, 20, which are connected one after the other and are operable serially and in parallel with reference to each other, are of different sizes.

This results in the air from air filter 62 being precompressed by compressor part 14 of first exhaust gas turbochargers 12 of the low-pressure supercharger, to a pressure level p_{1.1}, and reaching compressor part 22 of additional exhaust gas turbocharger 20 of the high-pressure supercharger. At that point, there follows an additional compression of the aspirated air to a pressure level of p₂, which corresponds to the supercharging pressure level. At supercharging pressure level p₂, the compressed air is conveyed, via an intercooler not shown in FIG. 3, to intake manifold 64, and from there to cylinder head 50 of internal combustion engine 30.

A first check valve denoted by reference numeral 66 prevents compressor part 14, of first exhaust gas turbocharger 12 of the low-pressure supercharger, from conveying air back to air filter 62 when a first switching element 68 is open

As soon as more fresh air has to be conveyed than compressor part 22 of additional exhaust gas turbocharger 20 of the high-pressure supercharger is able to supply, or the exhaust gas counterpressure p₃ becomes too great, the opening of first throttle valve 54 takes place, so that a part of the exhaust gas stream flows past turbine part 24 of additional exhaust gas turbocharger 20. For the control of supercharging pressure p₂, first throttle valve 54 may be opened or closed further, so that supercharging pressure p₂ is able to be controlled on the intake side. A second check valve 74 opens as soon as compressor part 22 of additional exhaust gas turbocharger 20 of the high-pressure supercharger is no longer supposed to, or able to effect an increase in pressure.

As soon as first throttle valve 54, that is connected in parallel to turbine part 24 of additional exhaust gas turbocharger 20 of the high-pressure supercharger, is completely open, almost no more work is expended by turbine part 24 of additional exhaust gas turbocharger 20 of the high-pressure supercharger, since the entire exhaust gas flow is conveyed, while circumventing turbine part 24 of additional exhaust gas turbocharger 20, to turbine part 16 of first exhaust gas turbocharger 12, that is, of the low-pressure supercharger. Pressure p_{3.2} corresponds approximately to exhaust gas counterpressure p₃. In order to further implement a supercharging pressure control, a control of pressure p₂, second throttle valve 60 is now used. Second check valve 74 acts so that the air conveyed by compressor part 14 of first exhaust gas turbocharger 12, of the low-pressure supercharger, is conveyed as much as possible without loss past compressor part 22 of additional exhaust gas turbocharger 20 of the high-pressure supercharger. In case more fresh air is required than compressor part 14 of first exhaust gas turbocharger 12 is in a position to supply, the system is switched over into operating mode “sequential supercharging”.

For this, there takes place the closing of first switching element 68, which is situated in the fresh air line and which connects the outlet of compressor part 14 of first exhaust gas turbocharger 12 of the low-pressure supercharger, at which pressure p_{1.1} prevails, with the intake of compressor part 22 of additional exhaust gas turbochargers 20. When first switching element 68, which is preferably designed as a flap, is closed, compressor part 22 of additional exhaust gas turbocharger 20 sucks air in. Second throttle valve 60 is open at the same time. Third check valve 78 prevents pressures p_{3.1}, on the outlet side of turbine part 24 of additional exhaust gas turbocharger 20, and p_{3.2}, at the intake of turbine part 16 of first exhaust gas turbocharger 12, from equalizing. The exhaust gas coming from exhaust gas manifold 52 is now divided up between turbine part 24 of additional exhaust gas turbocharger 20, that is, of the high-pressure supercharger, and turbine part 16 of first exhaust gas turbocharger 12, that is, the low-pressure supercharger. Compressor part 22 of additional exhaust gas turbochargers 20 can now compress additional air, so that an increase takes place in the air quantity conveyed into the combustion chambers of internal combustion engine 30, and a greater degree of charge, and thus it is possible to implement an increase in the performance of internal combustion engine 30. Compressor part 22 of additional exhaust gas turbochargers 20 and compressor part 14 of first exhaust gas turbocharger 12 are connected in parallel in operating mode “sequential supercharging”, and aspirate the fresh air in each case directly from air filter 62.

Compressor part 22 of additional exhaust gas turbocharger 20 is now able to compress additional aspirated fresh air, so that, in sum, more compressed fresh air is conveyed into the combustion chambers of internal combustion engine 30, and thus greater performance can be realized. Depending on the design, a wastegate valve 80 may be required, via which a possible excess exhaust gas mass flow is able to be conveyed past both turbine parts 24, 16. Third check valve 78 is particularly developed as a self-switching valve 82, but may also be developed as a regulating valve. In addition, first check valve 66 and second check valve 74 may also be developed as self-switching valve 82.

For the sake of completeness, it should be mentioned that a pressure p₄ is present at the outlet side of turbine part 16 of first exhaust gas turbocharger 12, and this pressure corresponds generally to the environmental pressure level plus a pressure loss, which sets in in a postconnected exhaust gas system. The supercharging device proposed according to the present invention may be operated in operating mode “stage supercharging” both in two stages and in one stage, and in operating mode “sequential supercharging” using two supercharging devices that are connected in parallel and preferably characterized as exhaust gas turbochargers.

The proposed supercharging device 10 according to an example embodiment of the present invention permits, in an advantageous manner, a supercharging pressure control of supercharging pressure p₂ in operating mode “two-stage regulated supercharging” by the operation of first throttle valve 54. In operating mode “sequential supercharging” at fully opened throttle valve 54, supercharging regulation of supercharging pressure p₂ takes place via wastegate valve 80. Using wastegate valve 80, the exhaust gas mass flow is determined which is conveyed via the two turbine parts 16 and 24, which are connected in parallel in operating mode “sequential supercharging.”

Using the example design approach according to the example embodiment of the present invention, the switching over from two-stage supercharging operation to sequential supercharging is able to take place by operating first switching element 68, which is preferably designed as an induction-manifold flap. In operating mode of two-stage supercharging operation, the regulation of the supercharging pressure takes place by first throttle valve 54, while in operating mode sequential supercharging, the supercharging pressure regulation takes place via first throttle valve 54 as well as wastegate valve 80.

What is claimed is:

1. A supercharging device for supercharging an internal combustion engine, comprising:
a first supercharging device and an additional supercharging device, which each have one compressor part and each have one turbine part, a supercharging pressure prevailing in an intake manifold on an intake side of the internal combustion engine, and an exhaust gas counterpressure prevailing in an exhaust gas manifold, on an outlet side of the internal combustion engine; and
a switching element situated in an intake tract of the internal combustion engine, between the compressor part of the first supercharging device and the compressor part of the additional supercharging device, adapted to switch over from a series connection of the compressor parts to a parallel connection of the compressor parts and vice versa.

2. The supercharging device as recited in claim 1, wherein a first throttle valve is connected in parallel to the turbine part of the additional supercharging device which, in the operating mode “two-stage supercharging”, is adjusted between its open position and its closed position.

3. The supercharging device as recited in claim 1, wherein an additional, second throttle valve is connected in parallel to the turbine part of the first supercharging device, which is closed in an operating mode “two-stage supercharging” and is postconnected to the turbine part of the additional supercharging device.

4. The supercharging device as recited in claim 3, wherein the first throttle valve, the second throttle valve and a wastegate valve carry out a regulation of the supercharging pressure on the intake side of the internal combustion engine.

5. The supercharging device as recited in claim 4, wherein the wastegate valve is situated in the exhaust gas manifold of the internal combustion engine.

6. The supercharging device as recited in claim 1, wherein the additional supercharging device takes in air directly via a first check valve via an air filter, when the first switching element is closed.

7. The supercharging device as recited in claim 4, wherein the regulation of the supercharging pressure in the operating mode “sequential supercharging” takes place at fully opened first throttle valve via the wastegate valve in the exhaust gas manifold.

8. The supercharging device as recited in claim 1, wherein a first automatically switching check valve is connected in parallel to the compressor part and the switching element in the intake manifold of the internal combustion engine.

9. The supercharging device as recited in claim 8, wherein an additional, second check valve is connected in parallel to the switching element and the compressor part of the additional exhaust gas turbocharger in the intake manifold of the internal combustion engine.

10. The supercharging device as recited in claim 9, wherein the first check valve and the second check valve are developed as automatically switching valves.

11. The supercharging device as recited in claim 10, wherein a third check valve is situated between the turbine part of the additional supercharging device and the turbine part of the first supercharging device.
